(19) United States
(12) Patent Application Publication
(10) Pub. No.: US 2017/0359280 A1
(43) Pub. Date: Dec. 14, 2017

(54) AUDIO/VIDEO PROCESSING METHOD AND DEVICE

(71) Applicant: BAIDU ONLINE NETWORK TECHNOLOGY (BEIJING) CO., LTD., Beijing (CN)

(72) Inventor: Ronghui ZHANG, Beijing (CN)

(73) Assignee: BAIDU ONLINE NETWORK TECHNOLOGY (BEIJING) CO., LTD., Beijing (CN)

(21) Appl. No.: 15/277,755

(22) Filed: Sep. 27, 2016

(30) Foreign Application Priority Data
Jun. 13, 2016 (CN) 201610420852.5

(51) Int. Cl. H04L 12/58

(52) U.S. Cl. CPC H04L 51/046; H04L 51/10

(57) ABSTRACT

The invention provides audio/video processing methods and devices. In one aspect, an embodiment of the invention can output the page where the audio/video to be shared is located through: obtaining shared information provided by an inviting party, the shared information containing information of audio/video to be shared and instant communication identification information of the inviting party; establishing, based on a confirm operation from the invited party in view of the shared information, instant communication connection with the inviting party using the instant communication identification information, for instant communication with the inviting party; and obtaining, based on the information of audio/video to be shared, the page where the audio/video to be shared is located, the page including instant communication page elements for input and/or output of communication information of instant communication with the inviting party. Because the audio/video to be shared and the instant communication page elements are disposed on the same page, the invited party can share exchanges regarding the viewed audio/video to be shared without having to switch again and again to a communication application, which features simple operation and thereby improves audio/video processing efficiency.

### TECHNICAL FIELD

The present invention relates to communication technology, and more particularly to audio/video processing method and device.

### BACKGROUND

With the development of communication technology, more and more functions are integrated into a terminal, so that the system function list of the terminal contains an increasing number of corresponding applications (APP). Some applications involve audio/video playing services, for example, Baidu video, etc. Typically, after viewing a good audio/video work, a user wants to recommend the audio/video work to his friends. The user can use a communication application in his terminal, for example, a messaging application, a Wechat application, a QQ application, etc., to provide related information regarding the audio/video work to his friends to view. During viewing of the work by the user and his friends, if there is demand for exchanges regarding the audio/video work, it is still necessary to communicate through communication applications on the respective terminals used by the user and his friends.

This way, however, requires both sides to repeatedly switch to communication applications for the exchanges regarding the audio and video being viewed, which might interrupt the audio/video playback and requires complicated operations, resulting in reduction of audio/video processing efficiency.

### SUMMARY

Aspects of the present invention provide an audio/video processing method and device for improving audio/video processing efficiency.

One aspect of the present invention provides an audio/video processing method, comprising:

obtaining shared information provided by an inviting party, the shared information containing information of audio/video to be shared and instant communication identification information of the inviting party;

establishing, based on a confirm operation from the invited party in view of the shared information, instant communication connection with the inviting party using the instant communication identification information, for instant communication with the inviting party;

obtaining, based on the information of audio/video to be shared, the page where the audio/video to be shared is located, the page including instant communication page elements for input and/or output of communication information of instant communication with the inviting party;

outputting the page where the audio/video to be shared is located.

As the above aspect and in any possible way of information, a way of implementation is further provided, the step of obtaining shared information provided by an inviting party comprises:

obtaining shared information provided by the inviting party from a communication application in the terminal used to obtain the shared information.

As the above aspect and in any possible way of information, a way of implementation is further provided, the information of audio/video to be shared is the address information of the page where the audio/video to be shared is located; the step of obtaining, based on the information of audio/video to be shared, the page where the audio/video to be shared is located comprises:

obtaining the audio/video to be shared based on the address information of the page where the audio/video to be shared is located.

As the above aspect and in any possible way of information, a way of implementation is further provided, the information of audio/video to be shared is the source information of the audio/video to be shared; the step of obtaining, based on the information of audio/video to be shared, the page where the audio/video to be shared is located comprises:

obtaining the audio/video to be shared based on the source information of the audio/video to be shared;

loading the audio/video to be shared into a specified page with an audio/video application in the terminal used to load the audio/video to be shared.

As the above aspect and in any possible way of information, a way of implementation is further provided, the method further comprises:

obtaining a first state of progress of the inviting party viewing the audio/video to be shared and a second state of progress of the invited party viewing the audio/video to be shared;

adjusting the first state of progress and/or the second state of progress, so as to make the first state of progress be consistent with the second state of progress.

As the above aspect and in any possible way of information, a way of implementation is further provided, the method further comprises:

displaying the instant communication page elements with floating components.

Another aspect of the present invention provides another audio/video processing method, comprising:

providing shared information to an invited party, the shared information containing information of audio/video to be shared and instant communication identification information of the inviting party;

establishing, based on a confirm operation from the invited party in view of the shared information, instant communication connection with the invited party using the instant communication identification information of the inviting party;

obtaining the page where the audio/video to be shared is located, the page including instant communication page elements for input and/or output of communication information of instant communication with the invited party;

outputting the page where the audio/video to be shared is located.

As the above aspect and in any possible way of information, a way of implementation is further provided, the step of providing shared information to an invited party comprises:

providing shared information to the invited party with a communication application in the terminal used to obtain the shared information.

As the above aspect and in any possible way of information, a way of implementation is further provided, the method further comprises:

obtaining a first state of progress of the inviting party viewing the audio/video to be shared and a second state of progress of the invited party viewing the audio/video to be shared;

adjusting the first state of progress and/or the second state of progress, so as to make the first state of progress be consistent with the second state of progress.

As the above aspect and in any possible way of information, a way of implementation is further provided, the method further comprises:

displaying the instant communication page elements with floating components.

Another aspect of the present invention provides an audio/video processing device, comprising:

an acquisition unit, used for obtaining shared information provided by an inviting party, the shared information containing information of audio/video to be shared and instant communication identification information of the inviting party;

a communication unit, used for establishing, based on a confirm operation from the invited party in view of the shared information, instant communication connection with the inviting party using the instant communication identification information, for instant communication with the inviting party;

a page unit, used for obtaining, based on the information of audio/video to be shared, the page where the audio/video to be shared is located, the page including instant communication page elements for input and/or output of communication information of instant communication with the inviting party;

an output unit, used for outputting the page where the audio/video to be shared is located.

As the above aspect and in any possible way of information, a way of implementation is further provided, the acquisition unit is specifically used for:

obtaining shared information provided by the inviting party from a communication application in the terminal used to obtain the shared information.

As the above aspect and in any possible way of information, a way of implementation is further provided, the information of audio/video to be shared is the address information of the page where the audio/video to be shared is located; the page unit is specifically used for:

obtaining the audio/video to be shared based on the address information of the page where the audio/video to be shared is located.

As the above aspect and in any possible way of information, a way of implementation is further provided, the information of audio/video to be shared is the source information of the audio/video to be shared; the page unit is specifically used for:

obtaining the audio/video to be shared based on the source information of the audio/video to be shared;

loading the audio/video to be shared into a specified page with an audio/video application in the terminal used to load the audio/video to be shared.

As the above aspect and in any possible way of information, a way of implementation is further provided, the output unit is further used for:

obtaining a first state of progress of the inviting party viewing the audio/video to be shared and a second state of progress of the invited party viewing the audio/video to be shared;

adjusting the first state of progress and/or the second state of progress, so as to make the first state of progress be consistent with the second state of progress.

As the above aspect and in any possible way of information, a way of implementation is further provided, the output unit is further used for:

displaying the instant communication page elements with floating components.

Another aspect of the present invention provides another audio/video processing device, comprising:

a sharing unit, used for providing shared information to an invited party, the shared information containing information of audio/video to be shared and instant communication identification information of the inviting party;

a communication unit, used for establishing, based on a confirm operation from the invited party in view of the shared information, instant communication connection with the invited party using the instant communication identification information of the inviting party;

a page unit, used for obtaining the page where the audio/video to be shared is located, the page including instant communication page elements for input and/or output of communication information of instant communication with the invited party;

an output unit, used for outputting the page where the audio/video to be shared is located.

As the above aspect and in any possible way of information, a way of implementation is further provided, the sharing unit is specifically used for:

providing shared information to the invited party with a communication application in the terminal used to provide the shared information.

As the above aspect and in any possible way of information, a way of implementation is further provided, the output unit is further used for:

obtaining a first state of progress of the inviting party viewing the audio/video to be shared and a second state of progress of the invited party viewing the audio/video to be shared;

adjusting the first state of progress and/or the second state of progress, so as to make the first state of progress be consistent with the second state of progress.

As the above aspect and in any possible way of information, a way of implementation is further provided, the output unit is further used for:

displaying the instant communication page elements with floating components.

As can be seen from the technical solutions, in one aspect, one can output the page where the audio/video to be shared is located through: obtaining shared information provided by an inviting party, the shared information containing information of audio/video to be shared and instant communication identification information of the inviting party; establishing, based on a confirm operation from the invited party in view of the shared information, instant communication connection with the inviting party using the instant communication identification information, for instant communication with the inviting party; and obtaining, based on the information of audio/video to be shared, the page where the audio/video to be shared is located, the page including instant communication page elements for input and/or output of communication information of instant communication with the inviting party. Because the audio/video to be shared and the instant communication page elements are disposed on the same page, the invited party can share exchanges regarding the viewed audio/video to be shared without having to switch again and again to a communication application, which features simple operation and thereby improves audio/video processing efficiency.

As can be seen from the technical solutions, in another aspect, one can output the page where the audio/video to be shared is located through: providing shared information to an invited party, the shared information containing information of audio/video to be shared and instant communication identification information of the inviting party; establishing, based on a confirm operation from the invited party in view of the shared information, instant communication connection with the invited party using the instant communication identification information of the inviting party; and obtaining, based on the information of audio/video to be shared, the page where the audio/video to be shared is located, the page including instant communication page elements for input and/or output of communication information of instant communication with the invited party. Because the audio/video to be shared and the instant communication page elements are disposed on the same page, the inviting party can share exchanges regarding the viewed audio/video to be shared without having to switch again and again to a communication application, which features simple operation and thereby improves audio/video processing efficiency.

In addition, with the technical solutions provided by the present invention, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In addition, the technical solutions provided by the present invention can greatly enhance user experiences.

### BRIEF DESCRIPTION OF DRAWINGS

In order to more clearly illustrate the technical solutions in the embodiments of the present invention, the drawings used for description of the embodiments or prior art will be briefly described; as is obvious, the drawings described below refer to some embodiments of the invention, those of ordinary skills can, without creative efforts, also obtain other drawings based on these drawings.

FIG. 1A is a schematic flowchart of an audio/video processing method according to one embodiment of the present invention;

FIG. 1B is a schematic diagram of the page where the audio/video to be shared is located in the embodiment in FIG. 1A;

FIG. 2 is a schematic flowchart of an audio/video processing method according to another embodiment of the present invention;

FIG. 3 is a schematic structure view of an audio/video processing device according to another embodiment of the present invention;

FIG. 4 is a schematic flowchart of an audio/video processing device according to another embodiment of the present invention.

### DETAILED DESCRIPTION

To show the object, technical solutions, and advantages of the embodiments of the invention more clearly, the technical solutions of the embodiments of the present invention will be described fully and clearly below in conjunction with the drawings of the embodiment of the invention. It is clear that the described embodiments are only part, not all, of the embodiments of the present invention. Based on the embodiments of the present invention, all other embodiments made by one of ordinary skill in the art without creative labor are within the protection scope of the present invention.

It should be noted that terminals involved in the embodiments of the present invention may include, but are not limited to, cell phones, personal digital assistants (PDA), wireless handheld devices, tablet computers, personal computers (PC), MP3 players, MP4 players, wearable devices (for example, smart glasses, smart watches, smart bracelet, etc.).

In addition, the term “and/or” is merely a description of the associated relationship of associated objects, indicating that three kinds of relationship can exist, for example, A and/or B, can be expressed as: the presence of A alone, presence of both A and B, presence of B alone. In addition, the character “/” generally represents an “OR” relationship between the associated objects before and after the character.

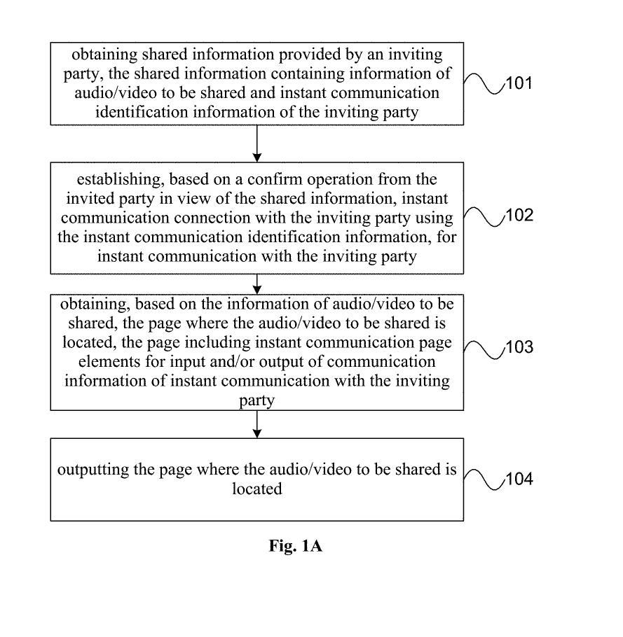

FIG. 1A is a schematic flowchart of an audio/video processing method according to one embodiment of the present invention, as shown in FIG. 1A.

101, obtaining shared information provided by an inviting party, the shared information containing information of audio/video to be shared and instant communication identification information of the inviting party;

102, establishing, based on a confirm operation from the invited party in view of the shared information, instant communication connection with the inviting party using the instant communication identification information, for instant communication with the inviting party;

The instant communication can include at least one of text message, audio massage, and video message. The present embodiment is not particularly limited.

103, obtaining, based on the information of audio/video to be shared, the page where the audio/video to be shared is located, the page including instant communication page elements for input and/or output of communication information of instant communication with the inviting party;

104, outputting the page where the audio/video to be shared is located.

In this way, the page where the audio/video to be shared is located can be displayed. Based on the output page, the invited party can carry out operations regarding audio/video playing, such as playback, pause, stop, and other operations.

It should be noted that part or all of the executive agent of 101 to 104 can be an application located in the terminal used by the invited party, a functional unit such as a plug-in or software development kit (SDK) disposed in an application located in the terminal used by the invited party, a processing engine in a network server, or a distributed system in a network. The present embodiment is not particularly limited to the aforementioned.

As can be understood, the application can be a native application installed in the terminal used by the invited party, or a web application of a browser in the terminal used by the invited party. The present embodiment is not particularly limited.

In this way, one can output the page where the audio/video to be shared is located through: obtaining shared information provided by an inviting party, the shared information containing information of audio/video to be shared and instant communication identification information of the inviting party; establishing, based on a confirm operation from the invited party in view of the shared information, instant communication connection with the inviting party using the instant communication identification information, for instant communication with the inviting party; and obtaining, based on the information of audio/video to be shared, the page where the audio/video to be shared is located, the page including instant communication page elements for input and/or output of communication information of instant communication with the inviting party. Because the audio/video to be shared and the instant communication page elements are disposed on the same page, the invited party can share exchanges regarding the viewed audio/video to be shared without having to switch again and again to a communication application, which features simple operation and thereby improves audio/video processing efficiency.

Alternatively, a possible implementation of this embodiment, at 101, one can obtain shared information provided by the inviting party from a communication application in the terminal used to obtain the shared information.

Specifically, the inviting party can use a communication application in his terminal, for example, micro-channel App, QQ App, SMS App, e-mail App, etc., to provide related information of the audio/video works to his friend, i.e., the invited party, for the invited party to view. In this way, one can directly obtain the shared information provided by the inviting party from the communication application.

Alternatively, in a possible implementation of this embodiment, at 101, the obtained instant communication identification information of the inviting party refers to an identity allocated to the inviting party for marking the inviting party himself during instant communication. After obtaining a confirm operation from the invited party in view of the shared information, one can further allocate an identity to the invited party and thus establish instant communication connection between the inviting party and the invited party with the respective identities allocated to the inviting party and the invited party, for instant communication between the inviting party and the invited party.

As can be understood, in this embodiment, the invited party can be one user or a plurality of users, the present embodiment is not particularly limited. Accordingly, if the invited party is a plurality of users, one can establish instant communication connection between the inviting party and a plurality of invited parties based on the identities respectively allocated to the inviting party and the plurality of invited parties, for group instant communication between the inviting party and the plurality of invited parties.

Alternatively, in a possible implementation of this embodiment, at 101, the obtained audio/video to be shared may include, but is not limited to, the address information of the page where the audio/video to be shared is located or the resource information of the audio/video to be shared. The present embodiment is not particularly limited.

In the present invention, the so-called page, sometimes also called the World Wide Web page, may be a page based on the HyperText Markup Language (HTML), namely a HTML page, a page based on HTML and Java language, namely a Java server page (JSP), or a page written with any other programming languages. The present embodiment is not particularly limited.

Specifically, the page may comprise one or more display blocks, referred to as page elements, defined by page labels such as HTML tags, JSP tags, etc., the elements can be, for example, texts, images, ultra links, buttons, input boxes, drop-down boxes, etc. The present embodiment is not particularly limited.

In particular, the address information of the page where the audio/video to be shared is located may include, but is not limited to, a Uniform Resource Locator (URL) or Uniform Resource Name (URN) of the page where the audio/video to be shared; it may also include other identity information that can be used to access the page where the audio/video to be shared is located. This embodiment is not particularly limited.

For example, if the information of audio/video to be shared is the address information of the page where the audio/video to be shared is located, at 103, one can specifically obtain the page where the audio/video is located based on the address information of the page where the audio/video to be shared is located.

In particular, the resource information of the audio/video to be shared may include, but is not limited to, the storage address of the audio/video to be shared.

For example, if the information of audio/video to be shared is the resource information of the audio/video to be shared is located, at 103, one can specifically obtain the page where the audio/video is located based on the resource information of the audio/video to be shared, and thus load the audio/video to be shared into a specified page with an audio/video application, such as Baidu Video & Audio application, in the terminal used to load the audio/video to be shared.

In the present invention, the instant communication page elements included in the page where the audio/video to be shared is located refers to a series of page elements for input and/or output of communication information of instant communication with the inviting party; they may include one page element or a plurality of page elements. This embodiment is not particularly limited.

Specifically, the instant communication page elements can be disposed at any position on the page where the audio/video to be shared is located, for example, on the entire area on the right of the page as shown in FIG. 1B, or, for another example, in the lower portion on the right of the page, etc. The present embodiment is not particularly limited.

Alternatively, in a possible implementation of the embodiment, during playback of the audio/video to be shared, if the invited party performs a full-screen playing operation, so as to play the audio/video to be shared in a full-screen mode, one can display the instant communication page elements with floating components.

Specifically, floating window components can be particularly used to realize the floating components. The floating window components, which are view components of the Android operating system, can particularly use the addView (View v) method of WindowManager class provided by the Android operating system to achieve adding floating window components, and use the removeView (View v) method to achieve removing the floating window components. The floating window components can perform pre-set response operations in response to move operations, click operations, and other operation events. For example, the floating window components can specifically trigger a call instruction in response to a click operation.

Further alternatively, one may further set the property of floating window components into: flags=LayoutParams.FLAG_NOT_TOUCH_MODAL| LayoutParams.FLAG_NOT_FOCUSABLE, so that the floating window components respond only to move operations, click operations, and other operation events within the range of the coordinates that are covered by the floating window components. In this way, it is possible not to affect anything outside the range of coordinates covered by the floating window components.

Further alternatively, one can specifically set transparency parameters for the floating window components. In particular, one can specifically set the transparency parameters of the floating window components to be values greater than 0 and less than 1, for example, value of 0.5, 0.9, etc., so as to achieve displaying semi-transparent floating window components. In this way, during instant communication with the inviting party, the audio/video to be shared and viewed will not be blocked, which can effectively improve audio/video playback reliability.

Further alternatively, one may further carry out operations to adjust displaying of the floating windows, such as minimizing or hiding the floating window components, based on instructions from the invited party.

Further alternatively, one may further detect whether the terminal displays the floating window components. If the floating window components disappeared upon abnormal reasons, i.e., the terminal fails to display the floating window components, one may specifically re-add floating window components through the addView (View v) method of WindowManager class provided by the Android operating system.

Alternatively, in a possible implementation of this embodiment, during playback of the audio/video to be shared, it is also possible to further obtain a first state of progress of the inviting party viewing the audio/video to be shared and a second state of progress of the invited party viewing the audio/video to be shared. Further, it is possible to adjust the first state of progress and/or the second state of progress, so as to make the first state of progress be consistent with the second state of progress.

In this way, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In this embodiment, one can output the page where the audio/video to be shared is located through: obtaining shared information provided by an inviting party, the shared information containing information of audio/video to be shared and instant communication identification information of the inviting party; establishing, based on a confirm operation from the invited party in view of the shared information, instant communication connection with the inviting party using the instant communication identification information, for instant communication with the inviting party; and obtaining, based on the information of audio/video to be shared, the page where the audio/video to be shared is located, the page including instant communication page elements for input and/or output of communication information of instant communication with the inviting party. Because the audio/video to be shared and the instant communication page elements are disposed on the same page, the invited party can share exchanges regarding the viewed audio/video to be shared without having to switch again and again to a communication application, which features simple operation and thereby improves audio/video processing efficiency.

In addition, with the technical solution provided by the present invention, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In addition, the technical solution provided by the present invention can greatly enhance user experiences.

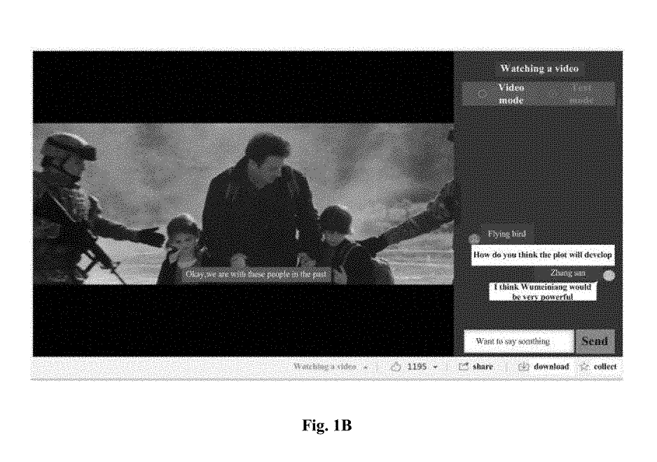

FIG. 2 is a schematic flowchart of an audio/video processing method according to another embodiment of the present invention, as shown in FIG. 2.

201, providing shared information to an invited party, the shared information containing information of audio/video to be shared and instant communication identification information of the inviting party;

202, establishing, based on a confirm operation from the invited party in view of the shared information, instant communication connection with the invited party using the instant communication identification information of the inviting party;

The instant communication can include at least one of text message, audio massage, and video message. The present embodiment is not particularly limited.

203, obtaining the page where the audio/video to be shared is located, the page including instant communication page elements for input and/or output of communication information of instant communication with the invited party;

204, outputting the page where the audio/video to be shared is located.

In this way, the page where the shared audio/video is located can be displayed. Based on the output page, the inviting party can carry out operations regarding audio/video playing, such as playback, pause, stop, and other operations.

It should be noted that part or all of the executive agent of 201 to 204 can be an application located in a local terminal used by the inviting party, a functional unit such as a plug-in or software development kit (SDK) disposed in an application located in a terminal used by the inviting party, a processing engine in a network server, or a distributed system in a network. The present embodiment is not particularly limited.

As can be understood, the application can be a native application installed in a terminal used by the inviting party, or a web application of a browser in a terminal used by the inviting party. The present embodiment is not particularly limited.

In this way, one can output the page where the audio/video to be shared is located through: providing shared information to an invited party, the shared information containing information of audio/video to be shared and instant communication identification information of the inviting party; establishing, based on a confirm operation from the invited party in view of the shared information, instant communication connection with the invited party using the instant communication identification information of the inviting party; obtaining the page where the audio/video to be shared is located, the page including instant communication page elements for input and/or output of communication information of instant communication with the invited party. Because the audio/video to be shared and the instant communication page elements are disposed on the same page, the inviting party can share exchanges regarding the viewed audio/video to be shared without having to switch again and again to a communication application, which features simple operation and thereby improves audio/video processing efficiency.

Alternatively, in a possible implementation of the embodiment, at 201, one can provide shared information to the invited party with a communication application in the terminal used to obtain the shared information.

Specifically, the inviting party can use a communication application in his terminal, for example, micro-channel App, QQ App, SMS App, e-mail App, etc., to provide related information of the audio/video works to his friend, i.e., the invited party, for the invited party to view. In this way, one can directly obtain the shared information provided by the inviting party from the communication application.

Alternatively, in a possible implementation of this embodiment, the related instant communication identification information of the inviting party refers to an identity allocated to the inviting party for marking the inviting party himself during instant communication. After obtaining a confirm operation from the invited party in view of the shared information, one can further allocate an identity to the invited party and thus establish instant communication connection between the inviting party and the invited party with the respective identities allocated to the inviting party and the invited party, for instant communication between the inviting party and the invited party.

As can be understood, in this embodiment, the invited party can be one user or a plurality of users, the present embodiment is not particularly limited. Accordingly, if the invited party is a plurality of users, one can establish instant communication connection between the inviting party and a plurality of invited parties based on the identities respectively allocated to the inviting party and the plurality of invited parties, for group instant communication between the inviting party and the plurality of invited parties.

Alternatively, in a possible implementation of this embodiment, the provided information of audio/video to be shared may include, but is not limited to, the address information of the page where the audio/video to be shared is located or the resource information of the audio/video to be shared. The present embodiment is not particularly limited.

In the present invention, the so-called page, sometimes also called the World Wide Web page, may be a page based on the HyperText Markup Language (HTML), namely a HTML page, a page based on HTML and Java language, namely a Java server page (JSP), or a page written with any other programming languages. The present embodiment is not particularly limited.

Specifically, the page may comprise one or more display blocks, referred to as page elements, defined by page labels such as HTML tags, JSP tags, etc., the elements can be, for example, texts, images, ultra links, buttons, input boxes, drop-down boxes, etc. The present embodiment is not particularly limited.

In particular, the address information of the page where the audio/video to be shared is located may include, but is not limited to, a Uniform Resource Locator (URL) or Uniform Resource Name (URN) of the page where the audio/video to be shared; it may also include other identity information that can be used to access the page where the audio/video to be shared is located. This embodiment is not particularly limited.

For example, if the information of audio/video to be shared is the address information of the page where the audio/video to be shared is located, after the invited party obtains the shared information, one can specifically obtain the page where the audio/video is located based on the address information of the page where the audio/video to be shared is located.

In particular, the resource information of the audio/video to be shared may include, but is not limited to, the storage address of the audio/video to be shared.

For example, if the information of audio/video to be shared is the resource information of the audio/video to be shared is located, after the invited party obtains the shared information, one can specifically obtain the page where the audio/video is located based on the resource information of the audio/video to be shared, and thus load the audio/video to be shared into a specified page with an audio/video application, such as Baidu Video & Audio application, in the terminal where the audio/video to be shared is located.

In the present invention, the instant communication page elements included in the page where the audio/video to be shared is located refers to a series of page elements for input and/or output of communication information of instant communication with the inviting party; they may include one page element or a plurality of page elements. This embodiment is not particularly limited.

Specifically, the instant communication page elements can be disposed at any position on the page where the audio/video to be shared is located, for example, the entire area on the right of the page as shown in FIG. 1B; or, for another example, in the lower portion on the right of the page, etc. The present embodiment is not particularly limited.

Alternatively, in a possible implementation of the present embodiment, at 202, if the inviting party is not currently viewing the audio/video to be shared, one can use the method for the invited party to obtain the page where the audio/video to be shared is located, whose details will be omitted here; if the inviting party is currently viewing the audio/video to be shared, one can obtain the page where the audio/video to be shared directly based on the current page.

Alternatively, in a possible implementation of the embodiment, during playback of the audio/video to be shared, if the invited party performs a full-screen playing operation, so as to play the audio/video to be shared in a full-screen mode, one can display the instant communication page elements with floating components.

Specifically, floating window components can be particularly used to realize the floating components. The floating window components, which is view components of the Android operating system, can particularly use the addView (View v) method of WindowManager class provided by the Android operating system methods to achieve adding floating window components, and use the removeView (View v) method to achieve removing floating window components. The floating window components can perform pre-set response operations in response to move operations, click operations, and other operation events. For example, the floating window components can specifically trigger a call instruction in response to a click operation.

Further alternatively, one may further set the property of floating window components into: flags=LayoutParams.FLAG_NOT_TOUCH_MODAL| LayoutParams.FLAG_NOT_FOCUSABLE, so that the floating window components respond only to move operations, click operations, and other operation events within the range of the coordinates that are covered by the floating window components. In this way, it is possible not to affect anything outside the range of coordinates covered by the floating window components.

Further alternatively, one can specifically set transparency parameters for the floating window components. In particular, one can specifically set the transparency parameters of the floating window components to be values greater than 0 and less than 1, for example, value of 0.5, 0.9, etc., so as to achieve displaying semi-transparent floating window components. In this way, during instant communication with the inviting party, the audio/video to be shared and viewed will not be blocked, which can effectively improve audio/video playback reliability.

Further alternatively, one may further carry out operations to adjust displaying of the floating window components, such as minimizing or hiding the floating window components, based on instructions from the inviting party.

Further alternatively, one may further detect whether the terminal used for displaying displays the floating window components. If the floating window components disappeared upon abnormal reasons, i.e., the terminal fails to display the floating window components, one may specifically re-add floating window components through the addView (View v) method of WindowManager class provided by the Android operating system.

Alternatively, in a possible implementation of this embodiment, during playback of the audio/video to be shared, it is also possible to further obtain a first state of progress of the inviting party viewing the audio/video to be shared and a second state of progress of the invited party viewing the audio/video to be shared. Further, it is possible to adjust the first state of progress and/or the second state of progress, so as to make the first state of progress be consistent with the second state of progress.

In this way, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In this embodiment, one can output the page where the audio/video to be shared is located through: providing shared information to an invited party, the shared information containing information of audio/video to be shared and instant communication identification information of the inviting party; establishing, based on a confirm operation from the invited party in view of the shared information, instant communication connection with the invited party using the instant communication identification information of the inviting party; and obtaining, based on the information of audio/video to be shared, the page where the audio/video to be shared is located, the page including instant communication page elements for input and/or output of communication information of instant communication with the invited party. Because the audio/video to be shared and the instant communication page elements are disposed on the same page, the inviting party can share exchanges regarding the viewed audio/video to be shared without having to switch again and again to a communication application, which features simple operation and thereby improves audio/video processing efficiency.

In addition, with the technical solution provided by the present invention, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In addition, the technical solution provided by the present invention can greatly enhance user experiences.

As should be noted, for the sake of simple description, each of the aforementioned embodiments of the method is described as a combination of a series of actions. Those skilled in the art, however, should be aware that the present invention is not limited to the orders of actions as described, because according to the present invention, some steps may employ other sequences or be carried out simultaneously. Secondly, those skilled in the art will also be aware that the embodiments described in the specification belong to preferred embodiments, the involved actions and modules are not necessarily a must for the present invention.

In the above embodiments, the descriptions of the various embodiments have different emphases, a part not included in a certain embodiment can be found in other described embodiments.

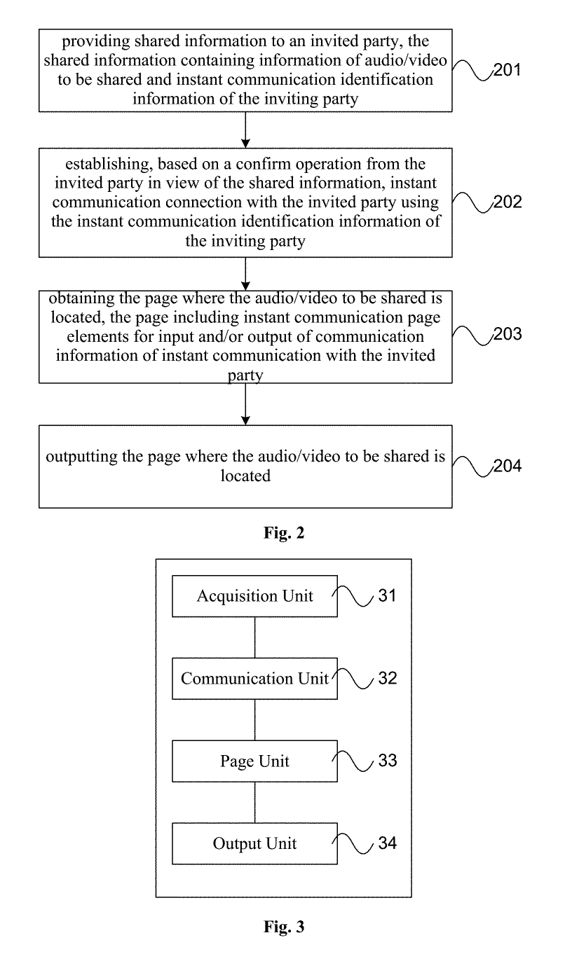

FIG. 3 is a schematic flowchart of an audio/video processing device according to another embodiment of the present invention, as shown in FIG. 3. An audio/video processing device according to the embodiment may comprise an acquisition unit 31, a communication unit 32, a page unit 33, and an output unit 34. The acquisition unit 31 is used for obtaining shared information provided by an inviting party, the shared information containing information of audio/video to be shared and instant communication identification information of the inviting party; the communication unit 32 is used for establishing, based on a confirm operation from the invited party in view of the shared information, instant communication connection with the inviting party using the instant communication identification information, for instant communication with the inviting party; the page unit 33 is used for obtaining, based on the information of audio/video to be shared, the page where the audio/video to be shared is located, the page including instant communication page elements for input and/or output of communication information of instant communication with the inviting party; the output unit 34 is used for outputting the page where the audio/video to be shared is located.

It should be noted that the audio/video processing device can be an application located in a terminal to be operated, a functional unit such as a plug-in or software development kit (SDK) disposed in an application located in a terminal to be operated, a processing engine in a network server, or a distributed system in a network. The present embodiment is not particularly limited to the aforementioned.

As can be understood, the application can be a native application installed in a terminal to be operated, or a web application of a browser in a terminal to be operated. The present embodiment is not particularly limited.

Alternatively, in one possible implementation of the present embodiment, the acquisition unit 31 can be specifically used for: obtaining shared information provided by the inviting party from a communication application in the terminal used to obtain the shared information.

Alternatively, in one possible implementation of the present embodiment, the information of audio/video to be shared is the address information of the page where the audio/video to be shared is located, the page unit 33 can be specifically used for: obtaining the audio/video to be shared based on the address information of the page where the audio/video to be shared is located.

Alternatively, in one possible implementation of the present embodiment, the information of audio/video to be shared is the source information of the audio/video to be shared; the page unit 33 is specifically used for: obtaining the audio/video to be shared based on the source information of the audio/video to be shared; loading the audio/video to be shared into a specified page with an audio/video application, such as Baidu Video & Audio application, in the terminal used to obtain the audio/video to be share.

Alternatively, in one possible implementation of the present embodiment the output unit 34 is further used for: obtaining a first state of progress of the inviting party viewing the audio/video to be shared and a second state of progress of the invited party viewing the audio/video to be shared; adjusting the first state of progress and/or the second state of progress, so as to make the first state of progress be consistent with the second state of progress.

Alternatively, in one possible implementation of the present embodiment, the output unit 34 is further used for: displaying the instant communication page elements with floating components.

As should be noted, the method of corresponding embodiment of FIG. 1A can be implemented by the audio/video processing device provided by this embodiment. One can refer to related part of the corresponding embodiment of FIG. 1A for detailed description, which will be omitted here.

In this embodiment, the output unit can output the page where the audio/video to be shared is located because of the following: obtaining shared information provided by an inviting party with an acquisition unit, the shared information containing information of audio/video to be shared and instant communication identification information of the inviting party; establishing with a communication unit, based on a confirm operation from the invited party in view of the shared information, instant communication connection with the inviting party using the instant communication identification information, for instant communication with the inviting party; and obtaining with a page unit, based on the information of audio/video to be shared, the page where the audio/video to be shared is located, the page including instant communication page elements for input and/or output of communication information of instant communication with the inviting party. Because the audio/video to be shared and the instant communication page elements are disposed on the same page, the invited party can share exchanges regarding the viewed audio/video to be shared without having to switch again and again to a communication application, which features simple operation and thereby improves audio/video processing efficiency.

In addition, with the technical solution provided by the present invention, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In addition, the technical solution provided by the present invention can greatly enhance user experiences.

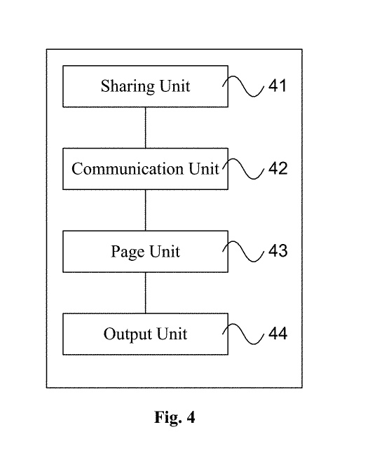

FIG. 4 is a schematic flowchart of an audio/video processing device according to another embodiment of the present invention, as shown in FIG. 4. An audio/video processing device according to the embodiment may comprise a sharing unit 41, a communication unit 42, a page unit 43, and an output unit 44. The sharing unit 41 is used for providing shared information to an invited party, the shared information containing information of audio/video to be shared and instant communication identification information of the inviting party; the communication unit 42 is used for establishing, based on a confirm operation from the invited party in view of the shared information, instant communication connection with the invited party using the instant communication identification information of the inviting party; the page unit 43 is used for obtaining the page where the audio/video to be shared is located, the page including instant communication page elements for input and/or output of communication information of instant communication with the invited party; the output unit 44 is used for outputting the page where the audio/video to be shared is located.

It should be noted that the audio/video processing device can be an application located in a terminal used by the inviting party, a functional unit such as a plug-in or software development kit (SDK) disposed in an application located in a terminal used by the inviting party, a processing engine in a network server, or a distributed system in a network. The present embodiment is not particularly limited to the aforementioned.

As can be understood, the application can be a native application installed in a terminal used by the inviting party, or a web application of a browser in a terminal used by the inviting party. The present embodiment is not particularly limited.

Alternatively, in a possible implementation of the present embodiment, the sharing unit 41 is specifically used for: providing shared information to the invited party with a communication application in the terminal used to obtain the shared information.

Alternatively, in a possible implementation of the present embodiment, the output unit 44 is further used for: obtaining a first state of progress of the inviting party viewing the audio/video to be shared and a second state of progress of the invited party viewing the audio/video to be shared; adjusting the first state of progress and/or the second state of progress, so as to make the first state of progress be consistent with the second state of progress.

Alternatively, in a possible implementation of the present embodiment, the output unit 44 is further used for: displaying the instant communication page elements with floating components.

As should be noted, the method of corresponding embodiment of FIG. 2 can be implemented by the audio/video processing device provided by this embodiment. One can refer to related part of the corresponding embodiment of FIG. 2 for detailed description, which will be omitted here.

In this embodiment, the output unit can output the page where the audio/video to be shared is located because of the following: providing shared information to an invited party with the sharing unit, the shared information containing information of audio/video to be shared and instant communication identification information of the inviting party; establishing with the communication unit, based on a confirm operation from the invited party in view of the shared information, instant communication connection with the invited party using the instant communication identification information of the inviting party; obtaining with the page unit, the page where the audio/video to be shared is located, the page including instant communication page elements for input and/or output of communication information of instant communication with the invited party. Because the audio/video to be shared and the instant communication page elements are disposed on the same page, the inviting party can share exchanges regarding the viewed audio/video to be shared without having to switch again and again to a communication application, which features simple operation and thereby improves audio/video processing efficiency.

In addition, with the technical solution provided by the present invention, because it is possible to adjust the first state of progress of the inviting party viewing the audio/video to be shared and/or the second state of progress of the invited party viewing the audio/video to be shared, it is possible to effectively ensure that the inviting party and the invited party have consistent states of progress of viewing the audio/video to be shared, which can improve the efficiency of exchanges regarding the viewed audio/video.

In addition, the technical solution provided by the present invention can greatly enhance user experiences.

Those skilled in the art can clearly understand that, for convenience and simplicity of description, the specific working processes of the aforementioned systems, devices, and units can be understood with references to the corresponding processes of the above embodiments, whose detailed description will not be repeated here.

As should be understood, in the various embodiments of the present invention, the disclosed systems, devices, and methods can be implemented through other ways. For example, the embodiments of the devices described above are merely illustrative. For example, the division of the units is only a logical functional division, the division may be done in other ways in actual implementations, for example, a plurality of units or components may be combined or be integrated into another system, or some features may be ignored or not implemented. Additionally, the displayed or discussed coupling or direct coupling or communicating connection between one and another may be indirect coupling or communicating connection through some interface, device, or unit, which can be electrical, mechanical, or of any other forms.

The units described as separate members may be or may be not physically separated, the components displayed as units may or may not be physical units, which can be located in one place, or distributed in a number of network units. One can select some or all of the units to achieve the purpose of the embodiments according to the embodiment of the actual needs.

Further, in the embodiment of the present invention, the functional units in each embodiment may be integrated in a processing unit, or each unit may be a separate physical existence, or two or more units can be integrated in one unit. The integrated units described above can be used both in the form of hardware, or in the form of software plus hardware.

The aforementioned integrated unit implemented in the form of software may be stored in a computer readable storage medium. Said functional units of software are stored in a storage medium, including a number of instructions to instruct a computer device (it may be a personal computer, server, or network equipment, etc.) or processor to perform some steps of the method described in various embodiments of the present invention. The aforementioned storage medium includes: U disk, removable hard disk, read-only memory (ROM), a random access memory (RAM), magnetic disk, or an optical disk medium may store program code.

Finally, as should be noted, the above embodiments are merely provided for describing the technical solutions of the present invention, not intended to limit them; although references to the embodiments of the present invention have been made to describe the details of the present invention, those skilled in the art will appreciate: one can still make changes on the technical solutions described in the various embodiments, or make equivalent replacements to some technical features; and such modifications or replacements do not make the essence of corresponding technical solutions depart from the spirit and scope of embodiments of the present invention.

1. An audio/video processing method, wherein the method comprises:
obtaining shared information provided by an inviting party, the shared information containing information of audio/video to be shared and instant communication identification information of the inviting party;
establishing, based on a confirm operation from the invited party in view of the shared information, instant communication connection with the inviting party using the instant communication identification information, for instant communication with the inviting party;
obtaining, based on the information of audio/video to be shared, the page where the audio/video to be shared is located, the page including instant communication page elements for input and/or output of communication information of instant communication with the inviting party;
outputting the page where the audio/video to be shared is located.

2. The method according to claim 1, wherein the step of obtaining shared information provided by an inviting party comprises:
obtaining shared information provided by the inviting party from a communication application in the terminal used to obtain the shared information.

3. The method according to claim 1, wherein the information of audio/video to be shared is the address information of the page where the audio/video to be shared is located; the step of obtaining, based on the information of audio/video to be shared, the page where the audio/video to be shared is located comprises:
obtaining the audio/video to be shared based on the address information of the page where the audio/video to be shared is located.

4. The method according to claim 1, wherein the information of audio/video to be shared is the source information of the audio/video to be shared; the step of obtaining, based on the information of audio/video to be shared, the page where the audio/video to be shared is located comprises:
obtaining the audio/video to be shared based on the source information of the audio/video to be shared;
loading the audio/video to be shared into a specified page with an audio/video application in the terminal used to load the audio/video to be shared.

5. The method according to claims 1, wherein, the method further comprises:
obtaining a first state of progress of the inviting party viewing the audio/video to be shared and a second state of progress of the invited party viewing the audio/video to be shared;
adjusting the first state of progress and/or the second state of progress, so as to make the first state of progress be consistent with the second state of progress.

6. The method according to claim 1, wherein the method further comprises:
displaying the instant communication page elements with floating components.

7. An audio/video processing method, wherein the method comprises:
providing shared information to an invited party, the shared information containing information of audio/video to be shared and instant communication identification information of the inviting party;
establishing, based on a confirm operation from the invited party in view of the shared information, instant communication connection with the invited party using the instant communication identification information of the inviting party;
obtaining the page where the audio/video to be shared is located, the page including instant communication page elements for input and/or output of communication information of instant communication with the invited party;
outputting the page where the audio/video to be shared is located.

8. The method according to claim 7, wherein the step of providing shared information to an invited party comprises:
providing shared information to the invited party with a communication application in the terminal used to obtain the shared information.

9. The method according to claim 7, wherein the method further comprises:
obtaining a first state of progress of the inviting party viewing the audio/video to be shared and a second state of progress of the invited party viewing the audio/video to be shared;
adjusting the first state of progress and/or the second state of progress, so as to make the first state of progress be consistent with the second state of progress.

10. The method according to claim 7, wherein the method further comprises:
displaying the instant communication page elements with floating components.

11. A nonvolatile computer storage medium, stored with one or more programs, which, when executed by an apparatus, make the apparatus to execute the following operation:
obtaining shared information provided by an inviting party, the shared information containing information of audio/video to be shared and instant communication identification information of the inviting party;
establishing, based on a confirm operation from the invited party in view of the shared information, instant communication connection with the inviting party using the instant communication identification information, for instant communication with the inviting party;
obtaining, based on the information of audio/video to be shared, the page where the audio/video to be shared is located, the page including instant communication page elements for input and/or output of communication information of instant communication with the inviting party;
outputting the page where the audio/video to be shared is located.

12. The nonvolatile computer storage medium according to claim 11, wherein the operation of obtaining shared information provided by an inviting party comprises:
obtaining shared information provided by the inviting party from a communication application in the terminal used to obtain the shared information.

13. The nonvolatile computer storage medium according to claim 11, wherein the information of audio/video to be shared is the address information of the page where the audio/video to be shared is located; the operation of obtaining, based on the information of audio/video to be shared, the page where the audio/video to be shared is located comprises:
obtaining the audio/video to be shared based on the address information of the page where the audio/video to be shared is located.

14. The nonvolatile computer storage medium according to claim 11, wherein the information of audio/video to be shared is the source information of the audio/video to be shared; the operation of obtaining, based on the information of audio/video to be shared, the page where the audio/video to be shared is located comprises:
obtaining the audio/video to be shared based on the source information of the audio/video to be shared;
loading the audio/video to be shared into a specified page with an audio/video application in the terminal where the audio/video to be shared is located.

15. The nonvolatile computer storage medium according to claim 11, wherein the one or more programs make the apparatus to further execute the following operation:
obtaining a first state of progress of the inviting party viewing the audio/video to be shared and a second state of progress of the invited party viewing the audio/video to be shared;
adjusting the first state of progress and/or the second state of progress, so as to make the first state of progress be consistent with the second state of progress.

16. The nonvolatile computer storage medium according to claim 11, wherein the one or more programs make the apparatus to further execute the following operation:
displaying the instant communication page elements with floating components.

17. A nonvolatile computer storage medium, stored with one or more programs, which, when executed by an apparatus, make the apparatus to execute the following operation:
providing shared information to an invited party, the shared information containing information of audio/video to be shared and instant communication identification information of the inviting party;
establishing, based on a confirm operation from the invited party in view of the shared information, instant communication connection with the invited party using the instant communication identification information of the inviting party;
obtaining the page where the audio/video to be shared is located, the page including instant communication page elements for input and/or output of communication information of instant communication with the invited party;
outputting the page where the audio/video to be shared is located.

18. The nonvolatile computer storage medium according to claim 17, wherein the apparatus of providing shared information to an invited party comprises:
providing shared information to the invited party with a communication application in the terminal used to obtain the shared information.

19. The nonvolatile computer storage medium according to claim 17, wherein the one or more programs make the apparatus to further execute the following operation:
obtaining a first state of progress of the inviting party viewing the audio/video to be shared and a second state of progress of the invited party viewing the audio/video to be shared;
adjusting the first state of progress and/or the second state of progress, so as to make the first state of progress be consistent with the second state of progress.

20. The nonvolatile computer storage medium according to claim 17, wherein the one or more programs make the apparatus to further execute the following operation:
displaying the instant communication page elements with floating components.

21. An apparatus, comprising:
one or more processors;
a memory;
one or more programs, which are stored in the memory, and execute the following operation, when executed by the one or more processors:
obtaining shared information provided by an inviting party, the shared information containing information of audio/video to be shared and instant communication identification information of the inviting party;
establishing, based on a confirm operation from the invited party in view of the shared information, instant communication connection with the inviting party using the instant communication identification information, for instant communication with the inviting party;
obtaining based on the information of audio/video to be shared, the page where the audio/video to be shared is located, the page including instant communication page elements for input and/or output of communication information of instant communication with the inviting party;
outputting the page where the audio/video to be shared is located.

22. The apparatus according to claim 21, wherein the operation of obtaining shared information provided by an inviting party comprises:
obtaining shared information provided by the inviting party from a communication application in the terminal used to obtain the shared information.

23. The apparatus according to claim 21, wherein the information of audio/video to be shared is the address information of the page where the audio/video to be shared is located; the operation of obtaining, based on the information of audio/video to be shared, the page where the audio/video to be shared is located comprises:
obtaining the audio/video to be shared based on the address information of the page where the audio/video to be shared is located.

24. The apparatus medium according to claim 21, wherein the information of audio/video to be shared is the source information of the audio/video to be shared; the operation of obtaining, based on the information of audio/video to be shared, the page where the audio/video to be shared is located comprises:
obtaining the audio/video to be shared based on the source information of the audio/video to be shared;
loading the audio/video to be shared into a specified page with an audio/video application in the terminal where the audio/video to be shared is located.

25. The apparatus according to claim 21, wherein the one or more programs execute the following operation:
obtaining a first state of progress of the inviting party viewing the audio/video to be shared and a second state of progress of the invited party viewing the audio/video to be shared;
adjusting the first state of progress and/or the second state of progress, so as to make the first state of progress be consistent with the second state of progress.

26. The apparatus according to claim 21, wherein the one or more programs execute the following operation:
displaying the instant communication page elements with floating components.

27. An apparatus, comprising:
one or more processors;
a memory;
one or more programs, which are stored in the memory, and execute the following operation , when executed by the one or more processors:
providing shared information to an invited party, the shared information containing information of audio/video to be shared and instant communication identification information of the inviting party;
establishing, based on a confirm operation from the invited party in view of the shared information, instant communication connection with the invited party using the instant communication identification information of the inviting party;
obtaining the page where the audio/video to be shared is located, the page including instant communication page elements for input and/or output of communication information of instant communication with the invited party;
outputting the page where the audio/video to be shared is located.

28. The apparatus according to claim 27, wherein the apparatus of providing shared information to an invited party comprises:
providing shared information to the invited party with a communication application in the terminal used to obtain the shared information.

29. The apparatus according to claim 27, wherein the one or more programs execute the following operation:
obtaining a first state of progress of the inviting party viewing the audio/video to be shared and a second state of progress of the invited party viewing the audio/video to be shared;
adjusting the first state of progress and/or the second state of progress, so as to make the first state of progress be consistent with the second state of progress.

30. The apparatus according to claim 27, wherein the one or more programs execute the following operation:
displaying the instant communication page elements with floating components.
